(19) United States
(12) Patent Application Publication
(10) Pub. No.: US 2019/0364943 A1
(43) Pub. Date: Dec. 5, 2019

(54) NOVEL COMPOSITIONS FOR FLAVOR ENHANCEMENT

(71) Applicant: International Flavors & Fragrances Inc., New York, NY (US)

(72) Inventors: Ajay Pratap SINGH, Union Beach, NJ (US); Diana Klaser CHENG, Union Beach, NJ (US); Jung-A KIM, Union Beach, NJ (US); Hsi-Wen CHIN, Union Beach, NJ (US); Thumpalasseril V. JOHN, Union Beach, NJ (US)

(73) Assignee: International Flavors & Fragrances Inc., New York, NY (US)

(21) Appl. No.: 16/461,598

(22) PCT Filed: Nov. 15, 2017
(86) PCT No.: PCT/US2017/061693

§ 371 Date: May 16, 2019

Related U.S. Application Data
(60) Provisional application No. 62/422,633, filed on Nov. 16, 2016.

(51) Int. Cl. A23L 27/23; A23L 27/00; A23L 2/56; A23L 19/18; A23L 13/40; A23G 3/36

(52) U.S. Cl. CPC A23L 27/23; A23L 27/88; A23L 2/56; A23V 2002/00; A23L 27/82; A23L 13/428; A23G 3/36; A23L 19/18

(57) ABSTRACT

The use of a nucleobase or a nucleoside in a consumable to provide taste specific enhancing effect is provided.

### STATUS OF RELATED APPLICATION

This application claims priority to U.S. Provisional Patent Application No. 62/422,633, filed Nov. 16, 2016, the contents hereby incorporated by reference as if set forth in its entirety.

### FIELD OF THE INVENTION

The present invention relates to novel compositions and methods for enhancing the sour taste, mouthwatering and the perception of juiciness and freshness in consumables.

### BACKGROUND OF THE INVENTION

Food industry has made significant effort to modify and harmonize taste in food products.

The basic categories of taste include salty, sweet, sour, bitter and umami The discovery of new taste modifiers that modify these basic tastes enables the creation of desirable flavors. However, currently available taste modifiers are generally non-selective and, as a result, the quality of the taste as a whole may be changed. Thus, it is of particular need to develop taste modifiers that provide flavor specific modifying effect. Such compounds selectively modify a particular type of taste without impacting the other flavors in a product.

### SUMMARY OF THE INVENTION

This invention provides novel methods for use of nucleobase guanine, its corresponding nucleoside guanosine or a mixture thereof in enhancing the sour taste in consumables.

In one embodiment, the present invention is directed to a method of enhancing the sour taste of a consumable by adding an olfactory effective amount of guanine, guanosine or a mixture thereof.

In another embodiment, the present invention is directed to a combination comprising an olfactory effective amount of guanine, guanosine or a mixture thereof and a consumable acid.

In another embodiment, the present invention is directed to a consumable containing an olfactory effective amount of guanine, guanosine or a mixture thereof and a consumable acid.

These and other embodiments of the present invention will be apparent by reading the following specification.

### DETAILED DESCRIPTION OF THE INVENTION

Sour taste promotes salivation, a mouthwatering sensation, and provides the perception of juiciness and freshness in consumables. Conventionally, a consumable acid is used to impart the sour taste. However, the use of an acid reduces the pH level and may consequently cause undesirable textural changes as well as ingredient degradation in consumables. Highly acidic foods have also been reported to be associated with a variety of health problems. In addition, currently available taste modifiers are generally non-selective and, as a result, the quality of the taste as a whole may be changed. Thus, there remains a need for novel taste enhancers that enhance sour taste in consumables in the absence of negative aroma or taste attributes, without altering the pH level and without impacting other flavors.

Nucleoside derivatives as well as nucleotides such as 5′-nucleotides including inosine monophosphate (IMP), adenosine 5′-monophosphate (AMP) and guanosine 5′-monophosphate (GMP) are widely known to provide umami or savory taste (Fuke, et al. (1993) Trends in Food Science and Technology 4: 246-251). However, very little has been achieved in the flavor use of nucleobases and nucleosides. To date, only adenosine has been reported to enhance sweetness, which may be associated with its effect of a-glucosidase inhibition (EP 0738475 A1; WO 2013/143822). It has now been unexpectedly discovered that nucleobase guanine and its corresponding nucleoside guanosine selectively enhance the sour taste, mouthwatering and the perception of juiciness and freshness in consumables. Guanine and guanosine can be obtained commercially, synthesized according to procedures known in the art, for example, as described in U.S. Pat. Nos. 6,242,599 and 3,332,935, or produced from bacterial strains or various botanicals. They can be produced from, for example, but not limited to, St. John's Wort (Hypericum perforatum), cranberry, endives, chicory, jujube, kiwi, pepinos, date fruits, black currant, honeysuckle, mate, allium, rape pollens, tomato, milk, Dong Quai, Luo Han Guo, honey, caterpillar fungus (Ophiocordyceps sinensis), meat products, fungus, yeasts, mushrooms, fish and other seafood.

A consumable includes, for example, a food product, a pharmaceutical composition, a dietary supplement, a nutraceutical, a dental hygienic composition and a cosmetic product. The consumable may further contain a flavoring.

In some embodiments, a consumable is a food product including, for example, but not limited to, fruits, vegetables, juices, meat products such as ham, bacon and sausage, egg products, fruit concentrates, gelatins and gelatin-like products such as jams, jellies, preserves and the like, milk products such as yogurt, ice cream, sour cream and sherbet, icings, syrups including molasses, corn, wheat, rye, soybean, oat, rice and barley products, nut meats and nut products, cereals, popcorn, cakes, cookies, crackers, chips, puddings, candies and nutritional bars confectionaries such as candies, gums, fruit flavored drops, and chocolates, chewing gums, mints, cheese, sauce, dips, condiments, dressings, gravies, marinades, fillings, frostings, toppings, creams, pies and breads. In a certain embodiment, the food product is a beverage including, for example, but not limited to, coffee, tea, carbonated soft drinks, such as COKE and PEPSI, non-carbonated soft drinks and other fruit drinks, sports drinks such as GATORADE and alcoholic beverages such as beers, wines and liquors. A consumable also includes prepared packaged products, such as granulated flavor mixes, which upon reconstitution with water provide non-carbonated drinks, instant pudding mixes, instant coffee and tea, coffee whiteners, malted milk mixes, pet foods, livestock feed, tobacco, and materials for baking applications, such as powdered baking mixes for the preparation of breads, cookies, cakes, pancakes, donuts and the like. A consumable also includes diet or low-calorie food and beverages containing little or no sucrose. A preferred consumable includes carbonated beverages. Consumables further include condiments such as herbs, spices and seasonings, flavor enhancers (e.g., monosodium glutamate), dietetic sweeteners and liquid sweeteners.

In other embodiments, a consumable is a pharmaceutical composition, a dietary supplement, a nutraceutical, a dental hygienic composition or a cosmetic product. Preferred compositions are pharmaceutical compositions containing naringenin, one or more pharmaceutically acceptable excipients, and one or more active agents that exert a biological effect other than sweetness enhancement. Such active agents include pharmaceutical and biological agents that have an activity other than taste enhancement. Such active agents are well known in the art (See, e.g., The Physician's Desk Reference). Such compositions can be prepared according to procedures known in the art, for example, as described in Remington's Pharmaceutical Sciences, Mack Publishing Co., Easton, Pa. In one embodiment, such an active agent includes a bronchodilator, an anorexiant, an antihistamine, a nutritional supplement, a laxative, an analgesic, an anesthetic, an antacid, a H2-receptor antagonist, an anticholinergic, an antidiarrheal, a demulcent, an antitussive, an antinauseant, an antimicrobial, an antibacterial, an antifungal, an antiviral, an expectorant, an anti-inflammatory agent, an antipyretic and a mixture thereof. In another embodiment, the active agent is selected from the group consisting of an antipyretic and analgesic, e.g., ibuprofen, acetaminophen or aspirin, a laxative, e.g., phenolphthalein dioctyl sodium sulfosuccinate, an appetite depressant, e.g., an amphetamine, phenylpropanolamine, phenylpropanolamine hydrochloride, or caffeine, an antacid, e.g., calcium carbonate, an antiasthmatic, e.g., theophylline, an antidiarrheal, e.g., diphenoxylate hydrochloride, an agent against flatulence, e.g., simethecon, a migraine agent, e.g., ergotamine tartrate, a psychopharmacological agent, e.g., haloperidol, a spasmolytic or sedative, e.g., phenobarbital, an antihyperkinetic, e.g., methyldopa or methylphenidate, a tranquilizer, e.g., a benzodiazepine, hydroxyzine, meprobramate or phenothiazine, an antihistaminic, e.g., astemizol, chlorpheniramine maleate, pyridamine maleate, doxlamine succinate, brompheniramine maleate, phenyltoloxamine citrate, chlorcyclizine hydrochloride, pheniramine maleate, or phenindamine tartrate, a decongestant, e.g., phenylpropanolamine hydrochloride, phenylephrine hydrochloride, pseudoephedrine hydrochloride, pseudoephedrine sulfate, phenylpropanolamine bitartrate, or ephedrine, a beta-receptor blocker, e.g., propranolol, an agent for alcohol withdrawal, e.g., disulfuram, an antitussive, e.g., benzocaine, dextromethorphan, dextromethorphan hydrobromide, noscapine, carbetapentane citrate, and chlophedianol hydrochloride, a fluorine supplement, e.g., sodium fluoride, a local antibiotic, e.g., tetracycline or clindamycin, a corticosteroid supplement, e.g., prednisone or prednisolone; an agent against gout, e.g., colchicine or allopurinol, an antiepileptic, e.g., phenytoin sodium, an agent against dehydration, e.g., electrolyte supplements, an antiseptic, e.g., cetylpyridinium chloride, a NSAID, e.g., acetaminophen, ibuprofen, naproxen, or a salt thereof, a gastrointestinal active agent, e.g., loperamide and famotidine, an alkaloid, e.g., codeine phosphate, codeine sulfate, or morphine, a supplement for trace elements, e.g., sodium chloride, zinc chloride, calcium carbonate, magnesium oxide, and other alkali metal salts and alkali earth metal salts; a vitamin, an ion-exchange resin, e.g., cholestyramine, a cholesterol-depressant and lipid-lowering substance, an antiarrhythmic, e.g., N-acetylprocainamide and an expectorant, e.g., guaifenesin. Examples of dietary supplements or nutraceuticals include, for example, but are not limited to, an enteral nutrition product for treatment of nutritional deficit, trauma, surgery, Crohn's disease, renal disease, hypertension, obesity and the like, to promote athletic performance, muscle enhancement or general well-being or inborn errors of metabolism such as phenylketonuria. In particular, such compositions can contain one or more amino acids which have a bitter or metallic taste or aftertaste. Such amino acids include, for example, but are not limited to, an essential amino acid such as L isomers of leucine, isoleucine, histidine, lysine, methionine, phenylalanine, threonine, tryptophan, tyrosine and valine. Dental hygienic compositions are known in the art and include, for example, but not limited to, a toothpaste, a mouthwash, a plaque rinse, a dental floss, a dental pain reliever (such as ANBESOL) and the like. In one embodiment, the dental hygienic composition includes one natural sweetener. In another embodiment, the dental hygienic composition includes more than one natural sweetener. In yet another embodiment, the dental hygienic composition includes sucrose and corn syrup, or sucrose and aspartame. A cosmetic product includes, for example, but not limited to, a face cream, a lipstick, a lip gloss and the like. Other suitable cosmetic products of use in this invention include a lip balm, such as CHAPSTICK or BURT'S BEESWAX Lip Balm.

In some embodiments, a flavoring includes, for example, but are not limited to, Natural Sweet Flavor#2 (WO 2012/129451), stevioside, rebaudioside A, rebaudioside B, rebaudioside C, rebaudioside D, rebaudioside E, rebaudioside F, dulcoside A, dulcoside B, stevia, alpha-glucosyl stevia, fructosyl stevia, galactosyl stevia, beta-glucosyl stevia, siamenoside, mogrosidc IV, mogroside V, Luo Han Guo sweetener, monatin and its salts, glycyrrhizic acid and its salts (e.g., as found in MAGNASWEET), curculin, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I or a combination thereof.

A consumable acid is an acid that is edible or suitable for human consumption at a given amount. A consumable acid includes, for example, but not limited to, acetic acid, allantoic acid, ec-ketoglutaric acid, ascorbic acid, aspartic acid, benzoic acid, cetostearic acid, citramalic acid, citric acid, formic acid, fumaric acid, galacturonic acid, glucuronic acid, glutamic acid, glyceric acid, glycolic acid, hydrochloric acid, isocitric acid, lactic acid, lactarimic acid, lactoisocitric acid, malic acid, oxaloacetic acid, oxalic acid, phosphoric acid, pyroglutamic acid, pyrrolidinonecarboxylic acid, pyruvic acid, quinic acid, shikimic acid, succinic acid, sulphuric acid and tartaric acid. A consumable acid of the present invention contributes to the sour taste of a consumable.

A sour taste enhancer is understood to mean a compound that itself possesses no sour taste but can increase and/or extend the sour taste in a consumable. The sour taste enhancer of the present invention refers to guanine, guanosine or a mixture thereof. The sour taste enhancer of the present invention enhances the sour taste, mouthwatering and the perception of juiciness and freshness in consumables.

The term “olfactory effective amount” is understood to mean the amount of a sour taste enhancing compound used in a consumable, wherein the sour taste enhancing compound increases and/or extends the sour taste of the consumable.

The olfactory effective amount may vary depending on many factors including other ingredients, their relative amounts and the olfactory effect that is desired. Any amount of a sour taste enhancing compound that provides the desired degree of sour taste enhancing effect without exhibiting off-taste can be used. In certain embodiments, the olfactory effective amount ranges from about 0.1 parts per trillion to about 500 parts per million by weight, more preferably from about 0.1 parts per billion to about 50 parts per million by weight, even more preferably from about 1 part per billion to about 5 parts per million by weight. The term “ppt” is understood to mean part per trillion by weight. The term “ppb” is understood to mean part per billion by weight. The term “ppm” is understood to mean part per million by weight.

Additional materials can also be used in conjunction with the compounds of the present invention to encapsulate and/or deliver the sour taste enhancing effect. Some well-known materials are, for example, but not limited to, polymers, oligomers, other non-polymers such as surfactants, emulsifiers, lipids including fats, waxes and phospholipids, organic oils, mineral oils, petrolatum, natural oils, perfume fixatives, fibers, starches, sugars and solid surface materials such as zeolite and silica. Some preferred polymers include polyacrylate, polyurea, polyurethane, polyacrylamide, polyester, polyether, polyamide, poly(acrylate-co-acrylamide), starch, silica, gelatin and gum Arabic, alginate, chitosan, polylactide, poly(melamine-formaldehyde), poly(urea-formaldehyde), or a combination thereof.

The invention is described in greater detail by the following non-limiting examples. Materials were purchased from Sigma-Aldrich unless noted otherwise.

### EXAMPLE I: ENHANCEMENT OF SOUR TASTE

Guanine in water (1 ppm) was described as somewhat astringent, mouth-drying and mouth-coating. Guanosine in water (1 ppm) was described as somewhat astringent, mouth-drying and slightly bitter. Neither guanine nor guanosine possessed sour taste. The enhancement of sour taste by guanine and guanosine was subsequently examined. A base solution of citric acid (HOC(COOH)(CH₂COOH)₂) in water (400 ppm) was prepared and used in the following examples of the present invention. Test sample solutions of guanine and guanosine were prepared in the base solution (each of 5 and 100 ppb, respectively).

Sample pairs (a base solution and a test sample solution) were presented in a blind and pseudorandom order to a sensory panel. The enhancement of sour taste was recorded based on the percentage of the panelists who ranked the sample sourer. Binomial statistical analysis was used to compare the enhancement of sour taste for each sample pair. Significance was at 95% Confidence Interval (p<0.05). The test results are as follows:

| Sample Solution | Result | p Value |
|---|---|---|
| Guanine (5 ppb) | Sourer than the base solution | <0.01* |
| Guanine (100 ppb) | Sourer than the base solution | <0.01* |
| Guanosine (5 ppb) | Sourer than the base solution | <0.01* |
| Guanosine (100 ppb) | Sourer than the base solution | <0.01* |

*Guanine and guanosine provided intense and lasting sour taste enhancement.

### EXAMPLE II: EFFECT OF GUANINE ON OTHER BASIC TASTES

The effect of guanine and its nucleobase analog adenine on other basic tastes was examined and compared. The control solutions were prepared as follows:

(i) A sweet control solution of sucrose in water (2.5% by weight);

(ii) A bitter control solution of caffeine in water (0.05% by weight);

(iii) A salty control solution of sodium chloride in water (0.3% by weight); and

(iv) An umami control solution of monosodium glutamate (MSG) in water (0.05% by weight).

Respective test solutions of adenine and guanine were prepared in different control solutions (2 or 20 ppm).

The taste perception of each sample was evaluated by a group of panelists using an intensity scale of 0 to 10, where 0=none, 5=moderate, 10=extremely strong. Panelists were instructed to anchor the intensity of the control solutions as 5 on the scale. The intensity scores were analyzed using one-way ANOVA with Post Hoc LSD multiple comparisons. Average intensity scores are reported in the following:

| Sample Solution | Sweet | Bitter | Salty | Umami |
|---|---|---|---|---|
| Control | 5.00 | 5.00 | 5.00 | 5.00 |
| Control + Adenine (2 ppm) | — | 6.33 | — | — |
| Control + Adenine (20 ppm) | 5.76 | — | 5.16 | 5.02 |
| p Value | 0.053 | 0.005* | 0.282 | 0.940 |
| Control + Guanine (2 ppm) | — | 6.50 | — | — |
| Control + Guanine (20 ppm) | 4.80 | — | 5.06 | 4.82 |
| p Value | 0.600 | <0.005* | 0.684 | 0.501 |

*Among all the basic tastes tested, adenine and guanine only affected bitterness.

Adenine and guanine exhibited similar effect. Both affected bitterness but showed no effect on sweet, salty or umami taste.

### EXAMPLE III: SELECTIVE ENHANCEMENT OF SOUR TASTE BY GUANINE

The effect of adenine and guanine on sour taste was examined and compared. Respective test sample solutions of adenine and guanine were prepared in the base solution (each of 5 and 100 ppb, respectively).

The sour taste perception of each sample was evaluated by a group of panelists using an intensity scale of 0 to 10, where 0=none, 5=moderate, 10=extremely strong. Panelists were instructed to anchor the intensity of the base solution as 5 on the scale. The intensity scores were analyzed using one-way ANOVA with Post Hoc LSD multiple comparisons. Average intensity scores are reported in the following:

| Sample Solution | Intensity Score | p Value |
|---|---|---|
| Base | 5.00 | N/A |
| Adenine (5 ppb) | 5.14 | 0.612 |
| Adenine (100 ppb) | 5.73 | 0.163 |
| Guanine (5 ppb) | 6.44 | <0.001* |
| Guanine (100 ppb) | 7.08 | <0.001* |

*Guanine resulted in significant increase in the perception of sour taste when compared to adenine.

Adenine and guanine exhibited similar effect on most basic tastes including bitter, sweet, salty and umami. However, guanine showed unique sour taste enhancement. Such enhancement is therefore highly selective and unexpected.

### EXAMPLE IV: ENHANCEMENT OF SOUR TASTE WITHOUT DECREASE OF pH LEVEL

A control sample solution of citric acid in water (450 ppm) and a test sample solution of guanosine in the base solution (1.25 ppm) were prepared.

Sample pairs of (i) a base solution and a control sample solution; and (ii) a test sample solution and a control sample solution were each presented in a blind and pseudorandom order to a sensory panel. The enhancement of sour taste was recorded based on the percentage of the panelists who ranked the sample sourer. The test results are as follows:

| Sample Solution | pH Level | Panelist Selection (%) |
|---|---|---|
| Base (citric acid, 400 ppm) | 3.19 | 0 |
| Control (citric acid, 450 ppm) | 3.17 | 100 |

| | pH | Panelist |
|---|---|---|
| Sample Solution | Level | Selection (%) |
| Test (citric acid, 400 ppm + guanosine,1.25 ppm) | 3.20 | 100 |
| Control (citric acid, 450 ppm) | 3.17 | 0 |

Guanosine at 1.25 ppm enhanced sour taste without decreasing the pH level. In addition, the enhancement was greater than that was achieved by 50 ppm citric acid.

### EXAMPLE V: EFFECT OF GUANOSINE ON OTHER BASIC TASTES

The effect of guanosine and its corresponding nucleotide, guanosine 5′-monophosphate (GMP), on additional basic tastes was examined and compared. The control solutions of sweet, bitter, salty and umami tastes were prepared as above in Example II. Respective test solutions of guanosine and GMP were prepared in different control solutions (2 or 20 ppm).

The taste perception of each sample was evaluated by a group of panelists using an intensity scale of 0 to 10, where 0=none, 5=moderate, 10=extremely strong. Panelists were instructed to anchor the intensity of the control solutions as 5 on the scale. The intensity scores were analyzed using one-way ANOVA with Post Hoc LSD multiple comparisons. Average intensity scores are reported in the following:

| Sample Solution | Sweet | Bitter | Salty | Umami |
|---|---|---|---|---|
| Control | 5.00 | 5.00 | 5.00 | 5.00 |
| Control + GMP (2 ppm) | — | 6.50 | — | — |
| Control + GMP (20 ppm) | 5.42 | — | 5.34 | 9.60 |
| p Value | 0.274 | <0.005* | <0.05* | <0.005* |
| Control + Guanosine (2 ppm) | — | 7.00 | — | — |
| Control + Guanosine (20 ppm) | 5.52 | — | 5.22 | 4.98 |
| p Value | 0.178 | <0.005* | 0.143 | 0.940 |

*Guanosine only affected bitterness, while GMP enhanced the perception of bitter, salty and umami tastes.

Guanosine and its salt GMP, similar in structures, exhibited remarkably distinct effect on basic tastes. GMP possessed strong effect in modifying more types of basic tastes.

### EXAMPLE VI: SELECTIVE ENHANCEMENT OF SOUR TASTE BY GUANOSINE

The effect of guanosine and GMP on sour taste was examined and compared. Respective test sample solutions of GMP and guanosine were prepared in the base solution (each of 5 and 100 ppb, respectively).

Sample pairs (a GMP solution and a guanosine solution) were presented in a blind and pseudorandom order to a sensory panel. The enhancement of sour taste was recorded based on the percentage of the panelists who ranked the sample sourer. Binomial statistical analysis was used to compare the enhancement of sour taste for each sample pair. Significance was at 95% Confidence Interval (p<0.05). The test results are as follows:

| Sample Pair | Result | p Value |
|---|---|---|
| GMP vs Guanosine (5 ppb) | Guanosine solution tasted sourer | <0.005* |
| GMP vs Guanosine (100 ppb) | Guanosine solution tasted sourer | <0.005* |

*Guanosine resulted in significant increase in the perception of sour taste when compared to GMP.

GMP and guanosine exhibited distinct effect on taste modification. GMP possessed strong effect and enhanced more basic tastes when compared with guanosine. However, guanosine showed unique sour taste enhancement. Such enhancement is therefore highly selective and unexpected.

### EXAMPLE VII: PREPARATION OF CHRYSANTHEMUM PARTHENIUM EXTRACT

Dried and cut Chrysanthemum parthenium aerial parts (commercially available from Monterey Bay Spice Company, California, U.S.) (100 g, 5 to 10 mesh size) were extracted with ethanol (60% by volume, 500 mL) at 60° C. for 3 hours. The extract was discharged and collected. The extraction step was repeated. Both extracts were pooled, filtered and dried to powder. The powder (10 g) was suspended in ethyl acetate (CH₃COOC₂H₅) (20 g) or isobutanol ((CH3)2CHCH₂OH) (10 g). The suspension was agitated at room temperature for 3 hours and subsequently filtered to recover the powder. The residual ethyl acetate or isobutanol in the powder was removed under vacuum at 50° C. A Chrysanthemum parthenium extract containing guanosine (139 ppm) and adenosine (32 ppm) was obtained.

### EXAMPLE VIII: PREPARATION OF GREEN COFFEE BEAN EXTRACT

Green coffee bean extract powder (commercially available from Guilin Layn, Gui Lin, China) (48 g) was dissolved in water (400 g). The pH level of the solution was adjusted to 7 using sodium hydroxide (NaOH). The solution was then heated to 50° C. and Viscozyme® (9.6 g) was added. The enzymatic treatment proceeded at 50° C. for 48 hours. The reaction was terminated by heat inactivation of the enzyme. The reaction solution was then dried to provide a green coffee bean extract containing guanosine (330 ppm) and adenosine (10 ppm) in a powder form.

### EXAMPLE IX: ENHANCEMENT OF SOUR TASTE BY BOTANICAL EXTRACT

The effect of botanical extract such as Chrysanthemum parthenium extract on sour taste was examined. A test sample solution of the extract in the base solution (15 ppm) was prepared.

Sensory evaluation was conducted using the paired comparison method. A base solution and a test sample solution, unidentifiable by using 3-digit codes, were presented in a blind and pseudorandom order to a sensory panel. The enhancement of sour taste was recorded based on the percentage of the panelists who ranked the sample sourer. The data were analyzed using binomial statistical analysis. As a result, the test sample solution containing the Chrysanthemum parthenium extract was reported to be significantly sourer than the base solution (p<0.05)

### EXAMPLE X: APPLICATION IN BEVERAGES

An orange juice beverage was prepared by adding sugar (120 g), orange juice concentrate 63° Brix (16.9 g), sodium citrate (HOC(COONa)(CH₂COONa)₂) (0.25 g), citric acid (2.15 g) and yellow #6 solution (1% by weight, 0.25 mL) in water to provide a total volume of 1 L. The orange juice beverages with and without the Chrysanthemum parthenium extract were prepared as follows.

| | | Test |
|---|---|---|
| Ingredient | Control (% by weight) | (% by weight) |
| Orange juice beverage | 99.85 | 99.70 |
| Orange flavor | 0.15 | 0.15 |
| Chrysanthemum parthenium | — | 0.15 |
| extract in water (1% by weight) | | |

Sensory evaluation was conducted by a sensory panel. The test sample was identified to be juicier, fresher, sourer, more refreshing and more authentic.

### EXAMPLE XI: APPLICATION IN CANDIES

The application of the invention in candies is shown in the following:

| | | Test |
|---|---|---|
| Ingredient | Control (% by weight) | (% by weight) |
| Chewy candy base | 98.90 | 98.75 |
| Watermelon Flavors | 0.30 | 0.30 |
| Citric acid/malic acid blend | 0.80 | 0.80 |
| (1:1 by weight) | | |
| Chrysanthemum parthenium | — | 0.15 |
| extract in water (1% by weight) | | |

The chewy candy base was prepared based on Applicants' proprietary formulation. Sensory evaluation was conducted by a sensory panel. The test sample was identified to be juicier, sourer and longer-lasting.

### EXAMPLE XII: APPLICATION IN MEAT PRODUCTS

The application of the invention in a meat product is shown in the following:

| | Control | |
|---|---|---|
| Ingredient | (% by weight) | Test (% by weight) |
| Water | 15.54 | 15.04 |
| Marinated chicken breast base | 84.46 | 84.46 |
| Green coffee bean extract in water | — | 0.50 |
| (1% by weight) | | |

Marinated chicken breast base was prepared based on Applicants' proprietary formulation. Sensory evaluation was conducted by a sensory panel. The test sample was identified to be juicier and more succulent.

### EXAMPLE XIII: APPLICATION IN CHIP PRODUCTS

The application of the invention in a chip product is shown in the following:

| | Control | |
|---|---|---|
| Ingredient | (% by weight) | Test (% by weight) |
| Crushed potato chip base | 100 | 95.50 |
| Green coffee bean extract in water | — | 0.50 |
| (1% by weight) | | |

Crushed potato chip base was prepared using PRINGLES based on Applicants' proprietary formulation. Sensory evaluation was conducted by a sensory panel. The test sample containing the green coffee bean extract was identified to be juicier, fresher and mouthwatering.

What is claimed is:

1. A method of enhancing the sour taste of a consumable comprising the step of adding an olfactory effective amount of a sour taste enhancer selected from the group consisting of guanine, guanosine and a mixture thereof to the consumable.

2. The method of claim 1, wherein the olfactory effective amount is from about 0.1 parts per trillion to about 500 parts per million by weight.

3. The method of claim 1, wherein the olfactory effective amount is from about 0.1 parts per billion to about 50 parts per million.

4. The method of claim 1, wherein the olfactory effective amount is from about 1 part per billion to about 5 parts per million.

5. The method of claim 1, wherein the sour taste enhancer is guanosine.

6. A combination comprising an olfactory effective amount of a sour taste enhancer selected from the group consisting of guanine, guanosine and a mixture thereof; and a consumable acid.

7. The combination of claim 6, wherein the olfactory effective amount is from about 0.1 parts per trillion to about 500 parts per million.

8. The combination of claim 6, wherein the olfactory effective amount is from about 0.1 parts per billion to about 50 parts per million

9. The combination of claim 6, wherein the olfactory effective amount is from about 1 part per billion to about 5 parts per million.

10. The combination of claim 6 further comprising a material selected from the group consisting of a polymer, an oligomer and a non-polymer.

11. The combination of claim 10, wherein the polymer is selected from the group consisting of polyacrylate, polyurea, polyurethane, polyacrylamide, polyester, polyether, polyamide, poly(acrylate-co-acrylamide), starch, silica, gelatin and gum Arabic, alginate, chitosan, polylactide, poly(melamine-formaldehyde), poly(urea-formaldehyde) and a combination thereof

12. The combination of claim 6, wherein the consumable acid is selected from the group consisting of acetic acid, allantoic acid, cc-ketoglutaric acid, ascorbic acid, aspartic acid, benzoic acid, cetostearic acid, citramalic acid, citric acid, formic acid, fumaric acid, galacturonic acid, glucuronic acid, glutamic acid, glyceric acid, glycolic acid, hydrochloric acid, isocitric acid, lactic acid, lactarimic acid, lactoisocitric acid, malic acid, oxaloacetic acid, oxalic acid, phosphoric acid, pyroglutamic acid, pyrrolidinonecarboxylic acid, pyruvic acid, quinic acid, shikimic acid, succinic acid, sulphuric acid, tartaric acid and a mixture thereof

13. The combination of claim 6, wherein the sour taste enhancer is guanosine.

14. The combination of claim 13 further comprising adenosine.

15. A consumable containing an olfactory effective amount of a sour taste enhancer selected from the group consisting of guanine, guanosine and a mixture thereof; and a consumable acid.

16. The consumable of claim 15, wherein the consumable acid is selected from the group consisting of acetic acid, allantoic acid, ec-ketoglutaric acid, ascorbic acid, aspartic acid, benzoic acid, cetostearic acid, citramalic acid, citric acid, formic acid, fumaric acid, galacturonic acid, glucuronic acid, glutamic acid, glyceric acid, glycolic acid, hydrochloric acid, isocitric acid, lactic acid, lactarimic acid, lactoisocitric acid, malic acid, oxaloacetic acid, oxalic acid, phosphoric acid, pyroglutamic acid, pyrrolidinonecarboxylic acid, pyruvic acid, quinic acid, shikimic acid, succinic acid, sulphuric acid, tartaric acid and a mixture thereof

17. The consumable of claim 15, wherein the consumable is selected from the group consisting of a food product, a pharmaceutical composition, a dietary supplement, a nutraceutical, a dental hygienic composition and a cosmetic product.

18. The consumable of claim 17, wherein the food product is a beverage, a candy, a meat product or a chip product.

19. The consumable of claim 15, wherein the sour taste enhancer is guanosine.

20. The consumable of claim 19 further comprising adenosine.
